(19) United States
(12) Patent Application Publication
(10) Pub. No.: US 2015/0093711 A1
(43) Pub. Date: Apr. 2, 2015

(54) HEAT TREATMENT FURNACE AND HEAT TREATMENT DEVICE HAVING THE SAME

(71) Applicant: Kabushiki Kaisha Toshiba, Minato-ku (JP)

(72) Inventor: Hideo CHIKAOKA, Kanagawa-ken (JP)

(73) Assignee: Kabushiki Kaisha Toshiba, Minato-ku (JP)

(21) Appl. No.: 14/317,385

(22) Filed: Jun. 27, 2014

(30) Foreign Application Priority Data
Sep. 30, 2013 (JP) 2013-205868

(51) Int. Cl. F27B 9/16

(52) U.S. Cl. CPC F27B 9/16
USPC 432/121

(57) ABSTRACT

A heat treatment furnace of an embodiment includes a chassis, a heater to heat an inside of the chassis, a table rotatably arranged in the chassis, in which an opening portion is formed at a central axis side, and a guide which is fixed inside the chassis, is arranged above the table, and is formed so as to become in a spiral shape from an outer circumferential side of the table toward the opening portion.

### CROSS-REFERENCE TO RELATED APPLICATION

This application is based upon and claims the benefit of priority from the prior Japanese Patent Application No. 2013-205868, filed on Sep. 30, 2013, the entire contents of which are incorporated herein by reference.

### FIELD

Embodiments described herein relate generally to a heat treatment furnace and a heat treatment device having the same.

### BACKGROUND

As an example of a conventional heat treatment device, there is a heat treatment device in which, in order to continuously perform heat treatment of a treatment object, a pair of rails are arranged in a spiral state on a floor surface, and heating means are arranged at an approximately equal interval on both sides of a pair of the rails, and heat insulating material is provided so as to surround the both sides of a pair of the rails.

And, at the time of performing heat treatment of the treatment object, a carriage which is loaded with the treatment object and runs on a pair of the rails is provided, and the carriage is made to run, to perform heat treatment.

### BRIEF DESCRIPTION OF THE DRAWINGS

FIG. 1 is a sectional perspective view of a heat treatment device according to an embodiment.

FIG. 2 is a perspective view showing the table of the heat treatment device according to the embodiment and treatment objects.

FIG. 3 is a view showing the table of the heat treatment device according to the embodiment and the treatment objects, and is a schematically sectional view according to a line segment A-A of FIG. 2.

FIG. 4 is a top view showing the movement of the treatment object of the heat treatment device according to the embodiment.

### DETAILED DESCRIPTION

A heat treatment furnace of an embodiment includes a chassis, a heater to heat an inside of the chassis, a table rotatably arranged in the chassis, in which an opening portion is formed at a central axis side, and a guide which is fixed inside the chassis, is arranged above the table, and is formed so as to become in a spiral shape from an outer circumferential side of the table toward the opening portion.

In addition, a heat treatment device of an embodiment includes a heat treatment furnace including, a chassis, a heater to heat an inside of the chassis, a table rotatably arranged in the chassis, in which an opening portion is formed at a central axis side, and a guide which is fixed inside the chassis, is arranged above the table, and is formed so as to become in a spiral shape from an outer circumferential side of the table toward the opening portion, and a cooling mechanism arranged at a vertical direction side for the chassis.

Hereinafter, an embodiment will be described in detail with reference to the drawings. In addition, the drawings are schematic or conceptual ones, and the shapes of the respective portions and the relation of longitudinal and lateral dimensions, and a ratio of sizes between the respective portions are not necessarily equal to those of the actual ones. In addition, when the same portions are shown, there may also be cases in which the dimensions and ratio thereof are indicated differently in the respective drawings.

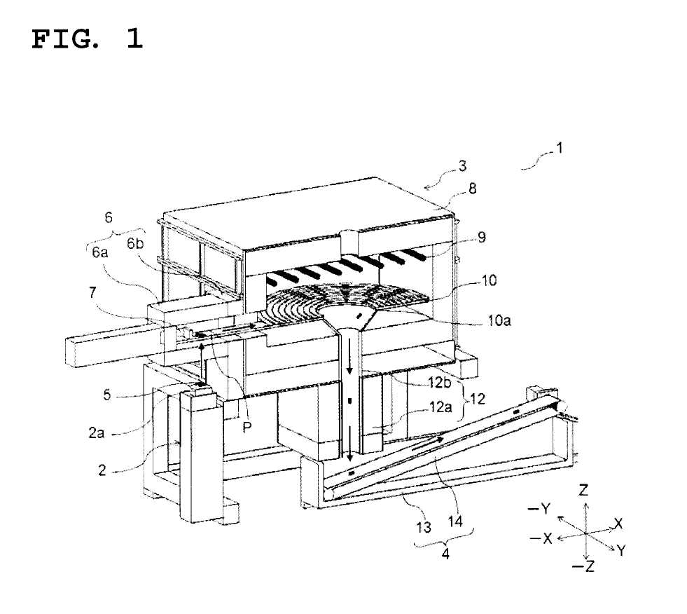

FIG. 1 is a sectional perspective view of a heat treatment device according an embodiment, and a heat treatment device 1 has a treatment object feeding portion 2, a heat treatment furnace 3, a cooling mechanism 4. In addition, the heat treatment device 1 according to the embodiment is a device for performing heat treatment of a magnet before magnetization as a treatment object 5, for example.

The treatment object feeding portion 2 is a mechanism to feed the treatment object 5 into the heat treatment furnace 3. The treatment object feeding portion 2 is provided movably in a Z-axis direction, and has a feeding table 2a which can load the treatment object 5 and feed it into the heat treatment furnace 3. In addition, in the present embodiment, the treatment object 5 is moved in the Z direction, and is fed into a gas replacement portion 6 described later of the heat treatment furnace 3, but without being limited to this, the treatment object feeding portion 2 may be provided so that the treatment objects 5 can be continuously fed into the heat treatment furnace 3.

The heat treatment furnace 3 is a furnace which continuously performs heat treatment of the treatment objects 4 fed by the treatment object feeding portion 2, and has the gas replacement portion 6, a treatment object input portion 7, a chassis 8, a heater 9, a table 10, and a rotation mechanism 12.

The gas replacement portion 6 is a configuration used at the time of performing the treatment object 5, and particularly used in a case to perform heat treatment in a gas atmosphere other than in the air atmosphere, and is a configuration for replacing the air atmosphere which enters when the treatment object 5 is fed, by a gas atmosphere other than the air atmosphere. In addition, it also plays a role to suppress air from entering into the chassis 8. In the present embodiment, at the time of performing heat treatment of the treatment object 5, the heat treatment is performed in the atmosphere of an inert gas such as Ar, for example.

The gas replacement portion 6 has a gas replacement chamber 6a and a gate valve 6b, and is provided so that the gas replacement chamber 6a and the chassis 8 are communicated with each other through the gate valve 6b. The gas replacement chamber 6a is a chamber for arranging the treatment object 5 fed from the treatment object feeding portion 2 therein, and for replacing the air atmosphere state to a gas atmosphere other than the air atmosphere. The gate valve 6b is provided so that it is closed till the gas in the gas replacement chamber 6a is replaced, and is opened after the gas is replaced.

With such a configuration, it is possible to suppress the air from entering in the chassis 8 in which heat treatment of the treatment object 5 is performed. In addition, since it is not necessary to replace the gas inside of the chassis 8, it becomes possible to effectively replace the gas.

In addition, in the present embodiment, the heat treatment is performed in the gas atmosphere other than the air atmosphere, but in the case of performing heat treatment in the air atmosphere, the gas replacement chamber 6a does not replace the gas, but may play a role as an arrangement portion to arrange the treatment object 5 fed from the treatment object feeding portion 2. In this case, the gate valve 6b may be provided, but may not be provided.

The treatment object input portion 7 is provided in the gas replacement chamber 6a of the gas replacement portion 6, and is a portion for pushing out the treatment object 5 fed from the treatment object feeding portion 2 on the table 10 arranged in the chassis 8. The treatment object input portion 7 moves the treatment object 5 using an actuator such as a cylinder, for example, and in the present embodiment, the treatment object input portion 7 is provided so as to move the treatment object 5 in an X-axis direction. In addition, in the present embodiment, the treatment object input portion 7 is provided so as to move the treatment object 5 in the X-axis direction, but it is not limited to this configuration.

In addition, when pushing the treatment objects 5 onto the table 10, the treatment object input portion 7 continuously pushes them with a fixed interval. And, when the treatment objects 5 are pushed out from the gas replacement chamber 6a onto the table 10 arranged in the chassis 8, the treatment objects 5 are pushed out on a plate-like member P, which is formed from a plate-like member, and is provided for continuing from the gas replacement chamber 6a to the table 10. In addition, in the present embodiment, the treatment objects 5 are pushed out on the plate-like member P, but without being limited to this, it is only necessary that the treatment objects 5 are pushed out from the gas replacement chamber 6a to the table 10.

The heater 9 and the table 10 are arranged inside the chassis 8, and the heater 9 is arranged immediately above the table 10 with a constant interval, so as to perform heat treatment of the treatment objects 5 arranged on the table 10. In addition, the inside of the chassis 8 is heated by the heater 9 to a high temperature not less than 1000 degrees. In addition, the heater 9 is provided immediately above the table 10, but without being limited to this, any arrangement may be used if it is provided at a position where the treatment objects 5 are evenly subjected to heat treatment.

The table 10 is a table for loading the treatment objects 5 pushed out by the treatment object input portion 7, and is formed into a circular shape. And, an opening portion 10a is formed at a central axis side of the table 10 so that the treatment object 5 is made to fall after being subjected to the heat treatment.

In addition, the table 10 is provided rotatably by the rotation mechanism 12 having a rotation drive portion 12a and a rotation support portion 12b.

The rotation drive portion 12a is a driving portion for rotating the rotation support portion 12b, and is arranged outside the chassis 8. In this manner, the rotation drive portion 12a is arranged outside the chassis 8, and thereby it becomes possible to mitigate an influence of the heat treatment furnace 3 in a high temperature state.

The rotation support portion 12b connects to the table 10, and is provided to penetrate through the chassis 8 in the Z-axis direction, and is rotatably arranged while being supported by the rotation drive portion 12a. For the reason, when the table 10 is rotated, the rotation support portion 12b is rotated by the rotation drive portion 12a, to cause the table 10 to be rotated.

The rotation support portion 12 connected to the table 10 is provided such that the inside thereof becomes hollow (so as to penetrate through) so as to communicate with the opening portion 10a formed in the table 10, and is formed so that the treatment object 5 which has fallen from the opening portion 10a can pass through the inside of the rotation support portion 12b.

In addition, the rotation support portion 12b is provided so that the cross-sectional area of an X-Y plane thereof becomes continuously narrower from the opening portion 10a of the table 10 toward the chassis 8, to form a tapered shape. And, the rotation support portion 12b is formed so that the cross-sectional area of the X-Y plane thereof from the chassis 8 toward the rotation drive portion 12a becomes an approximately constant cross-sectional area. In the present embodiment, the rotation support portion 12b is formed so that the cross-sectional area of the X-Y plane between the table 10 and chassis 8 becomes different from the cross-sectional area of the X-Y plane from the chassis 8 toward the rotation drive portion 12a, but without being limited to this, if it is possible to make the falling treatment object 5 pass through inside the rotation support portion 12b, the rotation support portion 12b may be provided so that the cross-sectional areas thereof become an equal cross-sectional area, for example.

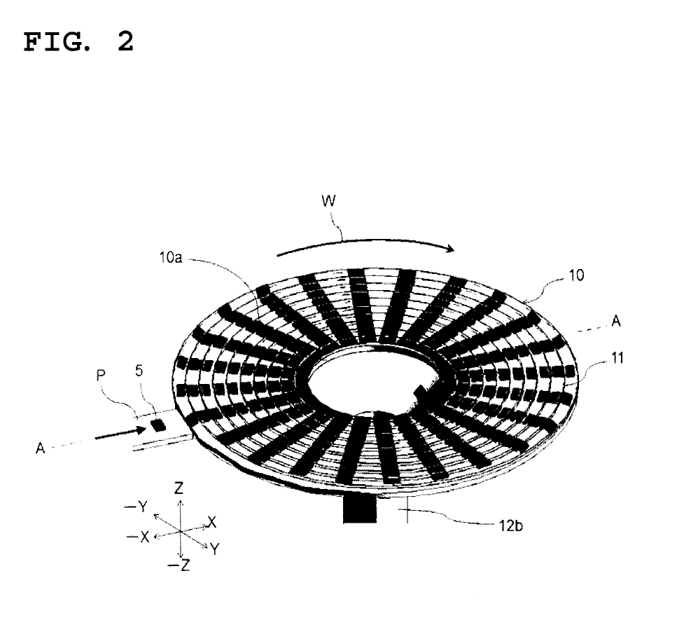

FIG. 2 is a perspective view showing the table of the heat treatment device according to the embodiment and the treatment objects. As the rotation direction of the table 10, the table 10 rotates toward a direction of an arrow W (a clockwise direction). In the present embodiment, the table 10 is rotated in the direction of the arrow W, but without being limited to this, the table 10 may rotate toward the reverse direction (a counterclockwise direction).

As a rotation speed of the table 10 and a feed rate of the treatment objects 5 which are to be fed on the table 10, the table 10 rotates and the treatment objects 5 are fed at such a speed that the treatment objects 5 can be arranged on the table 10 with a constant interval. In the present embodiment, the treatment objects 5 are fed in this manner, and thereby the treatment objects 5 are arranged so that they becomes radial for the opening portion 10a, but without being limited to this, if the treatment objects 5 are arranged so that the heat treatment times of the treatment objects 5 become uniform, the treatment objects 5 may be arranged in any manner.

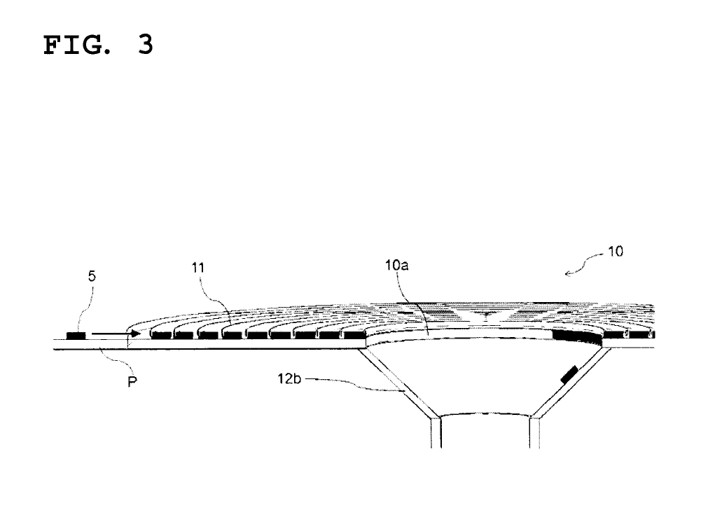

In addition, as shown in FIG. 2 and FIG. 3 (a schematic sectional view according a line segment A-A of FIG. 2), a guide 11 is arranged on the table 10 for inducing while rotating the treatment object 5 fed to the circumferential side of the table 10 to the opening portion 10a formed at the central axis side of the table 10.

The guide 11 is arranged above the table 10 with a constant interval, and is arranged at a height position where the treatment objects 5 can be induced. And, the guide 11 does not rotate with the table 10, but is fixed in the heat treatment furnace 3, and the guide 11 is formed to become in a spiral shape from the circumferential side (an outer circumferential side) toward the opening portion 10a. In addition, as a member for fixing the guide 11, any member may be used, and it is only necessary that the member does not rotate. In the present embodiment, a fixed interval is provided between the guide 11 and the table 10, but without being limited to this, if the guide 11 is arranged so that it does not rotate, the guide 11 may be in contact with the table 10.

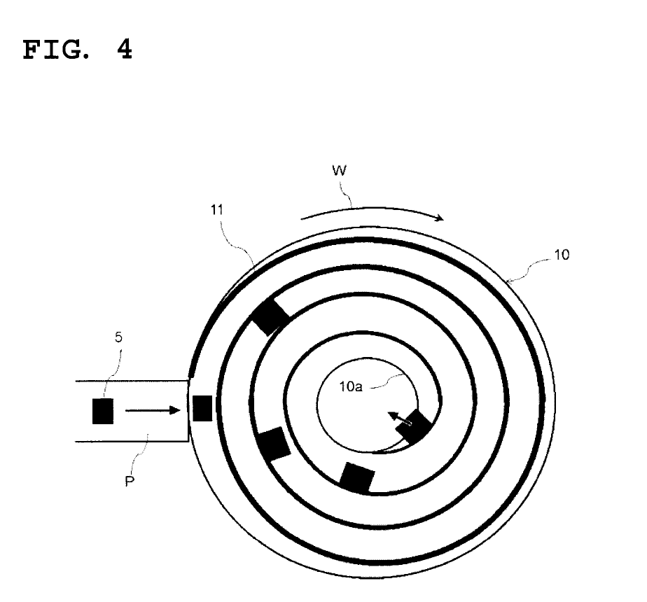

Next, the movement of the treatment object 5 will be described using FIG. 4. To begin with, when the treatment object 5 fed on the circumferential side of the table 10 is arranged on the table 10, the treatment object 5 rotates along with the table 10 toward the direction of the arrow W. And, the treatment object 5 is induced into a region between the fixed outside guide 11 and the inside guide 11 which are adjacent to each other, and moves little by little to the opening potion side 10a of the table 10 along the guide 11 while rotating. Finally, since the end portion of the guide 11 at the opening portion 10a side is arranged on the tangent of the opening portion 10a, an area where the table 10 and the treatment object 5 are in contact with each other gradually becomes narrower, and thereby the treatment object 5 falls inside the opening portion 10a.

In this manner, the treatment objects 5 are arranged and rotated on the table 10, and are induced by the guide 11 which has been fixed and formed in a spiral shape, and thereby it becomes possible to continuously treat the treatment objects 5 without inducing the treatment objects 5 using another member. By this means, it becomes possible to continuously perform heat treatment of the treatment objects 5, even under a higher temperature environment. In addition, it becomes possible to make the heat treatment times of the respective treatment objects 5 on the table 10 constant.

Accordingly, it is possible to provide the heat treatment furnace which can continuously perform heat treatment of the treatment object under a higher temperature environment, and the heat treatment device having the same.

The treatment object 5 which falls from the opening portion 10a of the table 10 through the rotation support portion 12b is cooled by the cooling mechanism 4 as shown in FIG. 1. The cooling mechanism 4 has a cooling tank 13 and a rotary belt 14.

In the cooling tank 13, coolant (not shown) for cooling the treatment object 5 is provided, and the cooling tank 13 is arranged at the falling direction side (vertical direction side) of the treatment object 5. As the coolant, it is possible to use oil, for example, but the coolant is not limited to this.

In the present embodiment, the cooling tank 13 is arranged in a (−Z)-axis direction for the heat treatment furnace 3. The cooling tank 13 is arranged in the free falling direction (vertical direction) as in the present embodiment, and thereby it becomes possible to rapidly cool the treatment object 5. In addition, when it is not necessary to rapidly cool the treatment object 5, the cooling tank 13 may not be arranged in the free falling direction.

In addition, the rotary belt 14 is provided in the cooling tank 13. The rotary belt 14 is a member for catching the treatment objects 5 falling into the cooling tank 13, and continuously moving the treatment objects 5 to a prescribed place. In the present embodiment, a mesh belt is used, for example, but without being limited to this, any belt may be used if it can continuously move the treatment objects 5.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A heat treatment furnace comprising:
a chassis;
a heater to heat an inside of the chassis;
a table rotatably arranged in the chassis, in which an opening portion is formed at a central axis side; and
a guide which is fixed inside the chassis, is arranged above the table, and is formed so as to become in a spiral shape from an outer circumferential side of the table toward the opening portion.

2. The heat treatment furnace according to claim 1, further comprising a rotation mechanism to rotate the table, wherein:
the rotation mechanism is provided outside the chassis; and
the rotation mechanism has a rotation support portion which connects to the opening portion of the table, and
a rotation drive portion to rotate the rotation support portion.

3. The heat treatment furnace according to claim 2, wherein:
an inside of the rotation support portion is penetrated through, so as to communicate with the opening portion of the table.

4. The heat treatment furnace according to claim 2, wherein:
the rotation mechanism is arranged at a vertical direction side for the chassis.

5. The heat treatment furnace according to claim 1, wherein:
a space between the table and the guide is arranged so as to be lower than a height of a treatment object to be arranged on the table.

6. The heat treatment furnace according to claim 1, further comprising:
a treatment object input portion to feed the treatment object to the table.

7. A heat treatment device comprising:
a heat treatment furnace comprising, a chassis, a heater to heat an inside of the chassis, a table rotatably arranged in the chassis, in which an opening portion is formed at a central axis side, and a guide which is fixed inside the chassis, is arranged above the table, and is formed so as to become in a spiral shape from an outer circumferential side of the table toward the opening portion; and
a cooling mechanism arranged at a vertical direction side for the chassis.

8. The heat treatment device according to claim 7, wherein:
the heat treatment furnace further comprises a rotation mechanism to rotate the table;
the rotation mechanism is provided outside the chassis; and
the rotation mechanism has a rotation support portion which connects to the opening portion of the table, and
a rotation drive portion to rotate the rotation support portion.

9. The heat treatment device according to claim 8, wherein:
an inside of the rotation support portion is penetrated through, so as to communicate with the opening portion of the table.

10. The heat treatment device according to claim 8, wherein:
the rotation mechanism is arranged at a vertical direction side for the chassis.

11. The heat treatment device according to claim 7, wherein:
a space between the table and the guide is arranged so as to be lower than a height of a treatment object to be arranged on the table.

12. The heat treatment device according to claim 7, wherein:
the heat treatment furnace further comprises a treatment object input portion to feed the treatment object to the table.
